(19) United States
(12) Patent Application Publication
(10) Pub. No.: US 2010/0230283 A1
(43) Pub. Date: Sep. 16, 2010

(54) ASSEMBLY AND ELECTROCHEMICAL SENSOR, ESPECIALLY CONDUCTIVITY SENSOR, WITH SUCH AN ASSEMBLY

(75) Inventors: Christian Fanselow, Erlau (DE); Torsten Pechstein, Radebeul (DE); Robert Scholz, Luttewitz/Dobeln (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Conducta Gesellschaft fur Mess - und Regeltechnik mbH + Co. KG, Gerlingen (DE)

(21) Appl. No.: 12/734,793

(22) PCT Filed: Nov. 27, 2008
(86) PCT No.: PCT/EP2008/066342

§ 371 Date: May 24, 2010

(30) Foreign Application Priority Data
Nov. 27, 2007 (DE) 102007057386.5

(51) Int. Cl. G01N 27/26; B32B 3/00; B29C 45/14

(52) U.S. Cl. 204/400; 428/172; 264/241

(57) ABSTRACT

An assembly, especially an assembly for an electrochemical sensor, includes a functional body of a first material, wherein the surface of the functional body is covered, at least sectionally, with a plastic, protective body. At least one free section of the surface of the functional body is not covered with a plastic, protective body, and wherein the free section is bordered by at least one surrounding, self-closing, boundary line, at which the plastic, protective body lies against the functional body. In the plastic, protective body, spaced from the boundary line, an elastic sealing ring lies sealingly against the surface of the functional body, in order to seal the functional body against a gap arising, in given cases, from the boundary line between the plastic, protective body and the functional body.

The present invention relates to an assembly, as well as to an electrochemical sensor, especially a conductivity sensor, with such an assembly.

An assembly of the technical field of the invention includes: A functional body, for example, a metal, functional body, which is surrounded, at least sectionally, by a plastic, protective body, especially a plastic, protective body injection molded around the functional body. Metal parts and other components of inorganic material are, most often, after pretreatment with a primer, jacketed with plastic by the injection molding method. The primer should, in such case, provide for good adhesion, and assure a sealed bonding, of the plastic to the metal surface. Although this procedure is basically guided by its goals, nevertheless, the application domain of assemblies of a metal, functional body surrounded by a plastic, protective body has narrow limits, because, due to the different coefficients of thermal expansion of metal and plastic, a sealing at the interface between the two materials is only possible over a limited temperature range. In the case of temperatures, which are too high, in fact, a gap can arise between the metal, functional body and the plastic, protective body surrounding it, into which gap, then, liquids and aggressive media can penetrate. This can lead, as a result, to the damaging, or destruction, of the assembly, or of an apparatus, containing the assembly. Equally, such gaps are ideal starting points for bacterial growth, so that assemblies according to the state of the art are only limitedly suitable for hygienic applications.

It is, therefore, an object of the present invention to provide an assembly having a functional body of, for example, metal or other inorganic material surrounded by a plastic, protective body, which assembly overcomes the described disadvantages of the state of the art.

Furthermore, it is an object of the invention to provide sensors, which overcome the described disadvantages.

The object is achieved according to the invention by the assembly of independent claim 1, as well as by the sensor of independent claim 14. Furthermore, the invention provides, for the solution of the object, a method of independent claim for injection molding of plastic around metal functional bodies.

The assembly of the invention includes a functional body of a first material, wherein the surface of the functional body is covered, at least sectionally, with a plastic, protective body, wherein at least one free section of the surface of the functional body is not covered with plastic, protective body, and wherein the free section is bordered by at least one surrounding, self-closing, boundary line, where the plastic, protective body lies against the functional body, characterized in that, in the plastic, protective body, spaced from the boundary line, an elastic sealing ring lies sealingly against the surface of the functional body, in order to seal the functional body against a gap arising, in given cases, from the boundary line between the plastic, protective body and the functional body.

The functional body can be surrounded, for example, with the plastic, protective body, wherein, in an embodiment of the invention, the free section protrudes out from the plastic, protective body, wherein the elastic sealing ring extends around the functional body, in order to seal the functional body against a gap arising, in given cases, from the boundary line between the plastic, protective body and the functional body.

The functional body can, in an embodiment of the invention, have a surrounding abutment surface, in order to support the sealing ring against a shifting perpendicular to a plane defined by the sealing ring. This is especially advantageous, when the applying of the plastic on the metal, functional body could lead to a shifting of the sealing ring, for example, from the associated injection pressure.

The functional body can, in another embodiment of the invention, have an essentially planar surface section, which contains the free section of the surface, wherein the sealing ring sealingly lies against the essentially flat surface section.

In a further development of the invention, the plastic, protective body can comprise, besides injected plastic, a formed part, which at least partially surrounds the sealing ring.

The formed part can serve especially for shielding the elastic sealing ring from hot plastic, when applying, or injecting, the plastic for forming the plastic, protective body.

The formed part can be, for example, a collar, which annularly surrounds the elastic sealing ring and, in given cases, lies against a face of the sealing ring, wherein the collar can be so embodied, that it biases the sealing ring all around against the functional body.

The collar can, for example, have a section, which annularly lies against the functional body on the side of the sealing ring facing away from the abutment surface.

The formed part can, in another embodiment of the invention, be embodied to have an annular shape and an essentially coaxial groove for accommodating the sealing ring, wherein the groove extends from a face of the formed part into the formed part. The formed part can, in a further development of this embodiment of the invention, bias the sealing ring against the flat surface section of the functional body.

In a further development of the invention, the formed part can be connected integrally with the injected plastic. For example, the formed part can have the same plastic, with which the surface of the functional body is covered.

By “integral connection” is meant a connection, in the case of which the materials of the formed part and the surrounding plastic fixedly cling to one another at their shared interface. This can be achieved, for example, by melting on the surface of the collar material, during the applying of the melted plastic or its components, or by a chemical reaction between the material of the formed part and the plastic.

The functional body can, especially, be of metal or semiconductor material. A metal, functional body can, for example, serve as electrode of a sensor, for example, an electrochemical sensor, especially a conductivity sensor,.

As electrode, the metal, functional body can have, for example, at least sectionally, a cylindrical shape.

The surface of the functional body covered, at least sectionally, with the plastic, protective body can, in a further development of the invention, be injection molded around with the plastic, especially a thermoplastic. For example, polyether sulphone (PES), polyetheretherketone (PEEK) or other high performance plastics are suitable.

The sensor of the invention includes: At least one assembly of the invention, wherein the free section of the surface of the functional body serves as a section of the sensor to be contacted with a medium to be measured. For example, the free section can be an electrode section of a conductivity sensor or an ion sensitive section of an ion sensitive, field effect transistor (ISFET). Furthermore, the sensor can be, for example, a humidity sensor or a temperature sensor.

A conductivity sensor of the invention can include at least two electrodes electrically insulated from one another, which can be supplied with a medium to be measured. For example, an assembly of the invention can be used for implementing the first electrode, and a second electrode, which includes an, at least sectionally, cylindrical, metal collar, can coaxially surround the assembly, in order to complete the conductivity sensor.

The method of the invention for manufacture of an assembly of the invention by injection molding plastic around a functional body, in order to form a plastic, protective body, includes steps as follows:

Positioning an elastic sealing ring on the functional body;

applying a formed part for protecting the elastic sealing ring from action of injected plastic and, in given cases, for biasing the sealing ring against the functional body; and,

at least sectionally, injection molding plastic around the functional body, for forming the plastic, protective body, wherein the formed part can enter into an integral connection with the injected plastic.

The invention will now be explained on the basis of an example of an embodiment illustrated in the drawing, the figures of which show as follows:

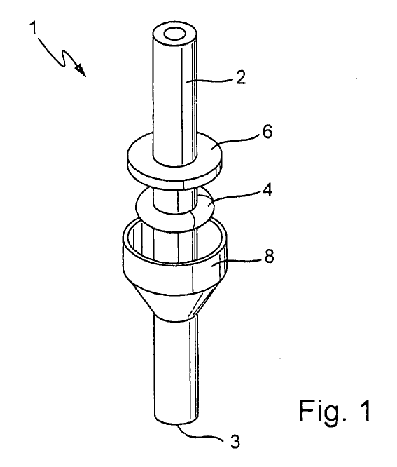

FIG. 1 a view of components of a first example of an embodiment of an assembly of the invention;

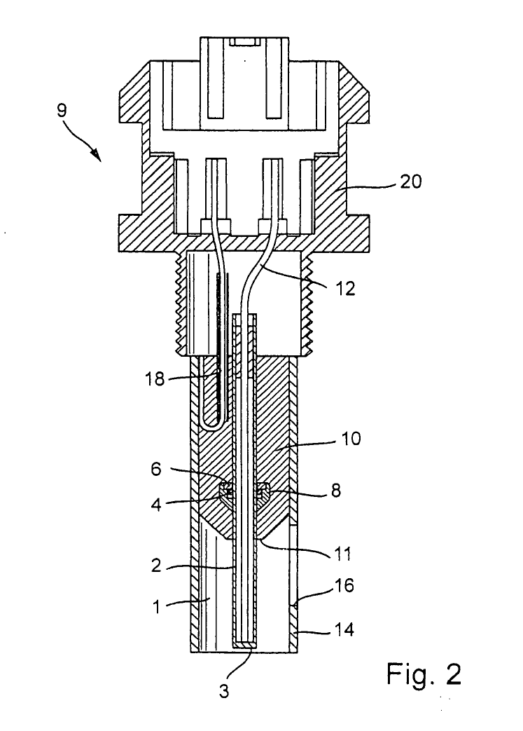

FIG. 2 a longitudinal section through a conductivity sensor of the invention containing an assembly of the invention; and

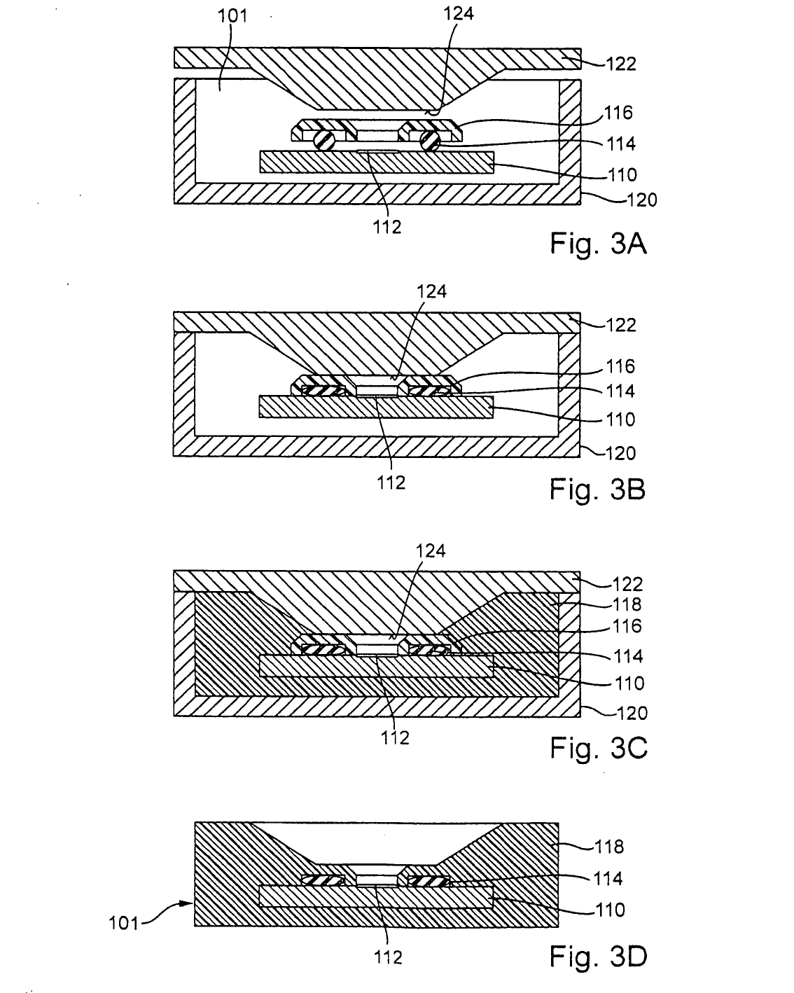

FIG. 3 longitudinal sections through an assembly of the invention for a pH, ISFET sensor in a sequence of manufacturing steps A to D.

FIG. 1 shows a cylindrical, metal body 2, which is manufactured of stainless steel, and which is to be injection molded around with a thermoplastic (which can comprise, especially, polyether sulphone (PES)) up to an axial end section adjoining its lower end 3,.

In this way, the metal cylinder is to be surrounded with an electrical insulator. PES is especially well suited to be the electrical insulator, since PES has good chemical resistance and, consequently, enables use of the assembly in electrochemical sensors. PES has, additionally, high form-stability. Thus, scarcely any elastic deformations are to be expected with components made from PES. Associated therewith, however, is a disadvantage, that the mentioned possible annular gaps between the cylindrical metal body (2) and a plastic jacketing (not shown) due to different coefficients of thermal expansion cannot be removed by elastic properties of the plastic jacketing. According to the invention, consequently, an elastic sealing ring (4) is pushed onto the cylindrical metal body (2), in order that the elastic material of the sealing ring (4), for example, elastomeric material, especially perfluoro elastomer or fluorine-containing rubber, can seal the cylindrical metal body (2) against the plastic, protective body surrounding it, even in the case of annular gap formation.

To the extent that, in the case of injection molding of plastic around the metal body (2), large forces are to be expected due to the viscosity of the plastic, it is advantageous to provide an abutment surface on the cylindrical metal body (2), in order to support the sealing ring (4). Such an abutment surface can be provided, for example, by means of a metal washer (6), which is affixed, for example, by frictional interlocking, or by welding or soldering to the cylindrical metal body (2). Before the injection molding, the sealing ring (4) is pushed tightly against the washer (6), in order to avoid further positional change during the injecting.

To the extent that a damaging of the elastic sealing ring (4) by the injected material is possible, the sealing ring (4) can furthermore be protected by a collar (8), wherein the collar is pushed over the sealing ring (4) and, in given cases, also over the washer (6). As not presented in FIG. 1 in greater detail, the collar can have a radial step, in order to assure, that the sealing ring (4) is pressed with a defined radial compressive pressure against the cylindrical metal body (2).

FIG. 2 shows the assembly of FIG. 1 in the installed state in an electrochemical sensor, namely a conductivity sensor. The assembly (1) with the cylindrical metal body (2) is then injection molded around by plastic (10), wherein the sealing component, composed of the sealing ring (4), the washer (6) and the collar (8) is spaced from the end (11) of the plastic body (10) by a distance of, for instance, a radius of the plastic body (10) surrounding the metal body (2). When, now, due to temperature fluctuations, an annular gap arises between the plastic body (10) and the cylindrical metal body (2), which is in contact with a medium surrounding the electrochemical sensor from the end (11) of the plastic body (10), then the annular gap is blocked by the elastic sealing ring (4), so that a further penetration of the medium to be measured into the assembly is prevented. Preferably, the collar (8) is of the same material as the material of the plastic body (10). Especially in the case of PES, during the injection molding around the metal body, the surface of the collar (8) is melted, so that the collar (8) becomes integrally connected with the material of the plastic body (10). This is advantageous, because, therewith, around the collar, no parallel contamination path can arise, which would bypass the elastic seal (4).

In the following, details of the conductivity sensor of the invention will be briefly explained. The cylindrical metal body (2) forms the inner electrode of a conductivity sensor having two coaxial electrodes, wherein the voltage, or the electrical current, of the inner electrode is registered via a line (12), which is in galvanic contact with the inner electrode via a central bore. Provided as outer electrode is a cylindrical, stainless steel jacket (14), which is applied on the likewise sectionally cylindrical, plastic body (10). The jacket (14) includes in its lower end section at least one passageway (16), in order to prevent the forming of gas bubbles around the central electrode (2) in the manner of the diving bell principle.

The potential, or the electrical current flow, of the outer electrode (14) is tapped via a line (18), which contacts the jacket at the lateral surface of the plastic body (10). The conductivity sensor includes, furthermore, a housing (20), in which an electronic circuit for operating the conductivity sensor is arranged. The details of the electronic circuit are, however, not of importance for the present invention.

The example of an embodiment shown in FIG. 3 relates to the assembly 101 of a pH, ISFET sensor, or, more exactly stated, the manufacturing steps for the mounting of the sensor carrier 110 with such a sensor in a housing 118, wherein the sensor carrier 110, in this case, corresponds to the functional body, and the housing includes the plastic, protective body. The sensor carrier 110 includes: A semiconductor sensor having an ion-sensitive gate section 112, which, in measurement operation, is to be supplied with a medium to be measured. Therefore, this gate section is to be kept free of plastic during the injection molding around the sensor carrier 110 with plastic for manufacturing the housing 118.

First, in the manufacturing step A, the sensor carrier 110 is positioned in an injection mold 120, wherein, on the sensor carrier 110 around the gate section 112, an elastic sealing ring 114 is placed, on which an annular, plastic, formed part 116 is superimposed, which has on its lower end a coaxially extending, annular groove, for receiving the sealing ring. In step B, the injection mold 120 is sealed by means of a lid 122, wherein the lid 122 has a pad 124, which, on the one hand, presses the plastic, formed part 116 down on the sensor carrier 110, so that the sealing ring 114 is biased into the annular groove of the plastic, formed part 116, and which, on the other hand, seals the plastic, formed part 116 on the side facing away from the sensor carrier, so that the gate section 112 surrounded by the plastic, formed part 116 is protected from the plastic (for example, polyether sulphone) injected in manufacturing step C into the injection mold 1120.

After the injected plastic is cured, or hardened, in the mold, the assembly 101 can be removed from the injection mold 120.

The plastic, formed part 116 can be, for example, of the same plastic injected in step C into the injection mold. Through melting on the surface of the plastic, formed part 116 without endangering the structural stability of the plastic, formed part, the plastic, formed part can enter into an integral connection with the injected housing material, and with this, together, form a plastic, protective body 118. The formed part can, insofar, be incorporated into the plastic, protective body. On the other hand, in microscopic or macroscopic examinations, the line of the boundary between the injected plastic and the plastic, formed part 116 is still quite recognizable.

1-15. (canceled)

16. An assembly, comprising:
a functional body comprising a first material;
a plastic protective body, wherein the surface of said functional body is, at least sectionally, covered with said plastic, protective body; and wherein at least one free section of said surface of said functional body is not covered with said plastic, protective body, said free section is bordered by at least one surrounding, self-closing, boundary line, at which said plastic, protective body lies against said functional body; and
an elastic sealing ring, in said plastic, protective body, spaced from said boundary line, lies sealingly against said surface of said functional body, in order to seal said functional body against a gap arising, in given cases, from said boundary line between said plastic, protective body and said functional body.

17. The assembly as claimed in claim 16, wherein:
said functional body is surrounded with said plastic, protective body;
said free section protrudes out from said plastic, protective body; and
said elastic sealing ring extends around said functional body, in order to seal said functional body against a gap arising, in given cases, from said boundary line between said plastic, protective body and said functional body.

18. The assembly as claimed in claim 17, wherein:
said functional body has a surrounding, abutment surface, in order to support said sealing ring against shifting perpendicular to a plane defined by said sealing ring.

19. The assembly as claimed in claim 16, wherein:
said functional body has an essentially planar surface section, which contains the free section of the surface; and
said sealing ring lies sealingly against said essentially planar surface section.

20. The assembly as claimed in claim 16, wherein:
said plastic, protective body comprises injected plastic and a formed part, which at least partially surrounds, or encloses, said sealing ring.

21. The assembly as claimed in claim 20, wherein:
said formed part comprises a collar, which annularly surrounds said elastic sealing ring; and
said collar surroundingly biases said sealing ring against said functional body.

22. The assembly as claimed in claim 20, wherein:
said collar has a section, which annularly lies against the side of said sealing ring facing away from the abutment surface on said functional body.

23. The assembly as claimed in claim 21, wherein:
said formed part is embodied annularly and has an essentially coaxial groove for accommodating said sealing ring; and
said groove extends from a face of said formed part into said formed part.

24. The assembly as claimed in claim 23, wherein:
said formed part biases said sealing ring against said planar surface section of said functional body.

25. The assembly as claimed in claim 20, wherein:
second formed part is connected integrally with the injected plastic.

26. The assembly as claimed in claim 25, wherein:
said formed part is of the same plastic as the injected plastic.

27. The assembly as claimed in claim 16, wherein:
said functional body comprises a metal, or a semiconductor material.

28. The assembly as claimed in claim 16, wherein:
said functional body surface, which is covered, at least sectionally, with said plastic, protective body, is injection molded around with the plastic; and
the plastic comprises especially a thermoplastic, especially polyether sulphone or polyetheretherketone.

29. An electrochemical sensor, which includes at least one assembly having:
a functional body comprising a first material;
a plastic protective body, wherein the surface of said functional body is, at least sectionally, covered with said plastic, protective body; and wherein at least one free section of said surface of said functional body is not covered with said plastic, protective body, said free section is bordered by at least one surrounding, self-closing, boundary line, at which said plastic, protective body lies against said functional body; and
an elastic sealing ring, in said plastic, protective body, spaced from said boundary line, lies sealingly against said surface of said functional body, in order to seal said functional body against a gap arising, in given cases, from said boundary line between said plastic, protective body and said functional body; wherein:
the free section of the surface of said functional body serves as a section of the sensor to be contacted with a medium to be measured, for example, as an electrode section of a conductivity sensor or as a sensitive section of an ion sensitive, field effect transistor (ISFET).

30. A method for the manufacture of an assembly, by injection molding of plastic around a functional body, for forming a plastic, protective body, and having a sealing ring, comprising the steps of:
positioning an elastic sealing ring on the functional body;
applying a formed part for protecting the elastic sealing ring against action of the injected plastic on the sealing ring and, in given cases, for biasing the sealing ring against the functional body; and,
at least sectionally, injection molding plastic around the functional body, for forming the plastic, protective body, wherein, especially, the formed part enters into an integral connection with the injected plastic.
